(19) United States
(12) Patent Application Publication
(10) Pub. No.: US 2018/0025229 A1
(43) Pub. Date: Jan. 25, 2018

(54) Method, Apparatus, and Storage Medium for Detecting and Outputting Image

(71) Applicant: Beijing Xiaomi Mobile Software Co., Ltd., Beijing (CN)

(72) Inventors: Yi DING, Beijing (CN); Deguo MENG, Beijing (CN); Enxing HOU, Beijing (CN)

(73) Assignee: Beijing Xiaomi Mobile Software Co., Ltd., Beijing (CN)

(21) Appl. No.: 15/590,292

(22) Filed: May 9, 2017

(30) Foreign Application Priority Data
Jun. 30, 2016 (CN) 201610514003.6

(51) Int. Cl. G06K 9/00; G06F 17/30; G08B 13/196

(52) U.S. Cl. CPC G06K 9/00744; G08B 13/1966; G06F 17/30247; G08B 13/19656

(57) ABSTRACT

A method, an apparatus, and a storage medium are provided for image outputting. The method may include: acquiring data frames collected by a target camera; acquiring a target image based on the data frames; and controlling a target terminal to output an alert message which at least includes the target image. When an emergency situation occurs in a user's home, the user can be notified of the emergency situation at once, thereby increasing the effective utilization of the smart camera device.

### CROSS-REFERENCE TO RELATED APPLICATION

This application is based on and claims priority of Chinese Patent Application No. 201610514003.6, filed on Jun. 30, 2016, which is incorporated herein by reference in its entirety.

### TECHNICAL FIELD

The present disclosure relates to the technical field of electronics, and more particularly to a method, an apparatus, and a storage medium for detecting and outputting image.

### BACKGROUND

With the continuous development of the smart terminal technology, various smart furniture and electrical appliances emerge constantly. Smart furniture and electrical appliances are more and more used in people's daily life and work, making people's life become increasingly convenient. With the wide spread use of smart cameras, it is possible to remotely monitor the situation in home through smart cameras even when a user is not at home. However, in the related art, the user has to view monitoring records on his/her own initiative, in order to get knowledge of the situation in the home. If an emergency situation occurs in the home, the user cannot get informed at once. Thus, the effective utilization of the smart cameras need to be improved.

### SUMMARY

In order to solve the foregoing technical problems, the present disclosure provides an image outputting method and apparatus, and a storage medium.

According to a first aspect of the present disclosure, a method is provided for outputting image. The method may include: acquiring data frames collected by a target camera; acquiring a target image based on the data frames; and controlling a target terminal to output an alert message which at least includes the target image.

According to a second aspect of the present disclosure, an image outputting apparatus is provided. The image outputting apparatus may include: a processor and a memory storing instructions executable by the processor. The processor is configured to: acquire data frames collected by a target camera; acquire a target image based on the data frames; and control a target terminal to output an alert message which at least includes the target image.

According to a third aspect of the embodiments of the present disclosure, there is provided a non-transitory computer-readable storage medium having stored therein instructions that, when executed by a processor of a mobile terminal, cause the mobile terminal to perform acts which may include: acquiring data frames collected by a target camera; acquiring a target image based on the data frames; and controlling a target terminal to output an alert message which at least includes the target image.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a diagram illustrating an exemplary system architecture where embodiments of the present disclosure are applicable according to an exemplary embodiment of the present disclosure.

FIG. 2 is a flowchart illustrating an image outputting method according to an exemplary embodiment of the present disclosure.

FIG. 3 is a flowchart illustrating another image outputting method according to an exemplary embodiment of the present disclosure.

FIG. 4 is a block diagram illustrating an image outputting apparatus according to an exemplary embodiment of the present disclosure.

FIG. 5 is a block diagram illustrating another image outputting apparatus according to an exemplary embodiment of the present disclosure.

FIG. 6 is a block diagram illustrating yet another image outputting apparatus according to an exemplary embodiment of the present disclosure.

FIG. 7 is a block diagram illustrating still another image outputting apparatus according to an exemplary embodiment of the present disclosure.

FIG. 8 is a structure schematic diagram illustrating an image outputting apparatus according to an exemplary embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of example embodiments of the present disclosure.

### DETAILED DESCRIPTION

Reference will now be made in detail to certain exemplary embodiments, examples of which are illustrated in the accompanying drawings. The following description refers to the accompanying drawings in which the same numbers in different figures represent the same or similar elements unless otherwise indicated. The implementations set forth in the following description of embodiments do not represent all implementations consistent with the disclosure. Instead, they are merely examples of apparatuses and methods consistent with aspects related to the disclosure as recited in the appended claims.

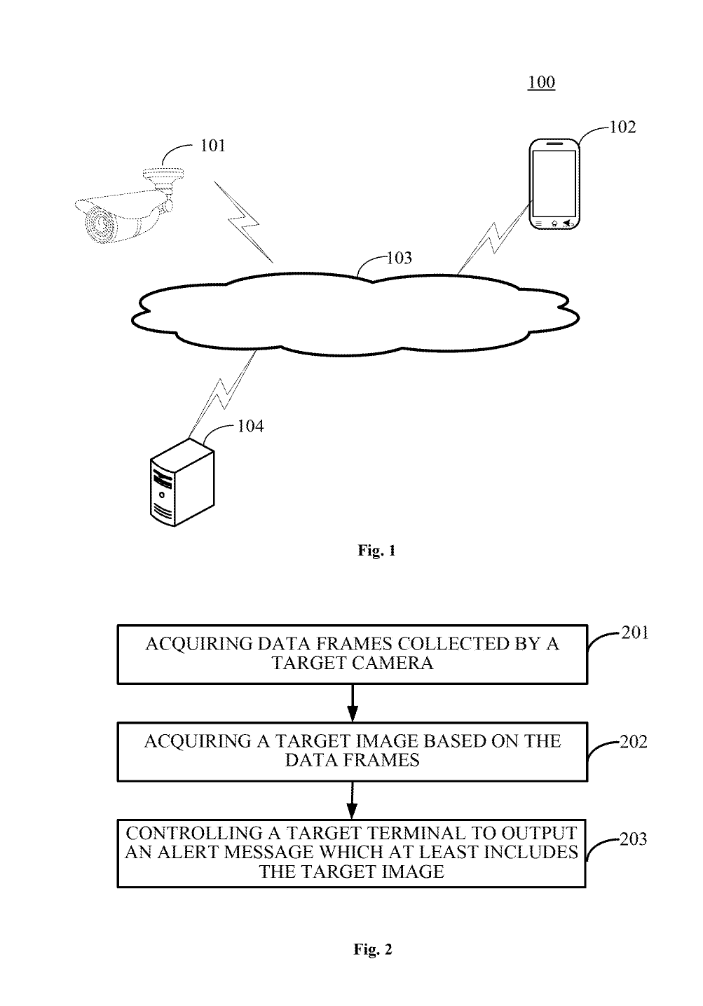

FIG. 1 is a schematic diagram of an exemplary system architecture where embodiments of the present disclosure are applicable.

As shown in FIG. 1, a system architecture 100 may include a camera device 101, a terminal device 102, a network 103, and a server 104. The network 103 provides communication links among the camera device 101, the terminal device 102, and the server 104.

The camera device 101 may be one of various devices with a photographing function, and may include one or more cameras configured to capture images and a processor configured to control the cameras. The camera device 101 may interact with the server 104 via the network 103, so as to send collected data to the server 104 or receive control instructions sent by the server. The terminal device 102 may also interact with the server 104 via the network 103, so as to receive or send a request or information etc. The terminal device 102 may be one of a variety of electronic devices, including but not limited to mobile terminal devices such as smart phones, smart wearable devices, tablet PCs, Personal Digital Assistance (PDAs), electric vehicles, and so on.

The server 104 can provide smart monitoring and management services, as well as a variety of other services. The server 104 may perform processing, such as storage and analysis, on the received data, and may also send information to the camera device 101 or the terminal device 102, etc. For example, the server 104 may receive the image data collected by the camera device 101, and analyze the received image data to determine whether an abnormal event has occurred in the area photographed by the camera device 101. If it is determined through analysis that there is an abnormal event in the area, to the server 104 may sort out the image data, acquire an abnormal image, and send the abnormal image to the terminal device 102 for viewing by the user. It can be understood that a server can provide one or more services and that the same service can be provided by a number of servers.

It should be understood that the number of camera devices, terminal devices, networks and servers in FIG. 1 is only illustrative. There may be any number of camera devices, terminal devices, networks and servers according to implementation requirements.

In the following, the present disclosure will be described in detail in combination with one or more embodiments.

FIG. 2 is a flowchart illustrating an image outputting method according to an exemplary embodiment. The method may be applied to a smart camera device or a server. As shown, the method may include at least the following steps.

At step 201, data frames collected by a target camera is acquired. In one or more embodiments, the target camera first collects image data of each frame, which is then acquired for analysis and processing by a server or other devices. Here, the target camera is used to photograph a monitored target area. For example, when a user wants to photograph a doorway area, the camera photographing the doorway area may be used as a target camera.

At step 202, a target image is acquired based on the data frames. In one or more embodiments, the target image is an image including an abnormal event. Depending on the application scenario of the target camera, the target camera may have a plurality of pre-defined events for the user to select. Here, the application scenario may indicate at least a target area of the target camera and a time period to watch the target area. In each application scenario, the target camera may provide one or more pre-defined events.

The abnormal event thus may be defined using at least one of: an application scenario, an object image in the application scenario, an acceptable identity photo, a preset threshold for changes in the application scenario. The acceptable identity photo may include all the photos of family members and friends. The object image may be a portrait photo, a drawing on the wall, a safe, etc.

Further, the abnormal event may be defined by one or more of the following: a stranger photo; a target area; and an object in the target area. The stranger photo may include a photo of an unwelcoming guest, etc. The target area may be selected or adjusted remotely by the user using an electronic device that controls the smart camera device.

Furthermore, the abnormal event may be defined by one or more of the following: a target area and a type of hazard in the target area. The type of hazard may include fire, strong wind, snow, smoke, earthquake, etc.

For example, the target area may be a window, a bedroom, a hall way, a living room, a home entrance, a baby bed, etc. When the target area is the home entrance or a hall way, the pre-defined events may include: stranger approaching, animals approaching, vehicle approaching, stationary objects moving, fire hazard, dogs running out, etc. When a user selects “stranger approaching” from the pre-defined events, the target image may be an image in which a stranger entering the monitored target area is photographed. When the user selects “stationary objects moving” from the pre-defined events, the target image may be an image in which a change happening to a stationary object in the monitored target area (e.g. a certain object in the monitored target area being blown down, or things hanging on a wall loosening and falling down etc.) is photographed. When the user selects “fire hazard” from the pre-defined events, the target image may be an image in which the monitored target area being on fire is photographed, etc. It could be understood that the target image may be some other form of alert message, and specific contents and forms of the target image are not limited in the present disclosure.

In some embodiments, it is possible to analyze the acquired image data in each data frame, and to determine whether the image corresponding to the data frame includes an abnormal event. If an abnormal event is included, then the image corresponding to the data frame may be determined and generated as a target image.

At step 203, a target terminal is controlled to output an alert message, which at least includes the target image. In one or more embodiments, after acquiring the target image, it is possible to first generate an alert message which at least includes the target image and then transfer the alert message to a target terminal, so that the target terminal can present the alert message to the user. The target terminal is exactly the one used by the same user as the camera device acquiring the target image. For example, the target terminal may be a terminal having the same user account as the camera device, and may also be a terminal associated with the camera device, etc.

In this embodiment, the alert message may also include voice information, which may for example alert a user to check monitoring records. It may also include alarm information, such as an audible alarm with a predetermined sound. The alert message may also include text alert information, which may be for example pushed to alert a user to check monitoring records. It could be understood that the alert message may include some other form of alert message, and specific contents and forms of the alert message are not limited in the present disclosure.

According to the image outputting method provided by the foregoing embodiment of the present disclosure, data frames collected by a target camera is acquired, a target image is acquired based on the data frames, and a target terminal is controlled to output an alert message which at least includes the target image. Thus, when an emergency situation occurs in a user's home, the user can be notified of the emergency situation at once, thereby increasing the effective utilization of the smart camera device.

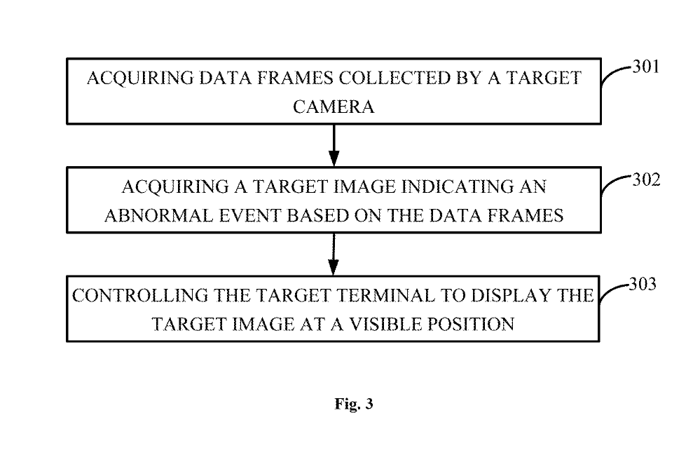

FIG. 3 is a flowchart illustrating another image outputting method according to one or more exemplary embodiments, wherein the process of acquiring a target image based on data frames and controlling a target terminal to output an alert message is further detailed. The method may be applied to a smart camera device or a server. As shown, the method may include the following steps.

At step 301, data frames collected by a target camera is acquired.

At step 302, a target image indicating an abnormal event is acquired based on the data frames.

In some embodiments, the abnormal event may include one or more of the following events: a stranger has entered a target area; a location of an object in the target area has changed; and the target area has been on fire etc. It could be understood that the abnormal event may be some other event, and specific contents and forms of the abnormal event are not limited in the present disclosure. The target area may be a monitored target area photographed by the target camera, and the choice of the target area is not limited in the present disclosure. A user may select the abnormal events of interest using an electronic device that communicates with the target camera. The user may also define the abnormal events with some descriptions using natural languages.

When no abnormal event occurs, there will be no change between images corresponding to data of adjacent frames. If an abnormal event occurs, multiple images corresponding to data of adjacent frames recording the abnormal event will differ. Accordingly, it is possible to determine whether acquired data frame corresponds to a target image indicating an abnormal event, based on whether the acquired data frame changes or how much the acquired data frame changes.

To be more specific, first, each similarity between data of every two adjacent frames among the data frames is acquired one by one. This can be done by using any implementable algorithm, and the specific way of acquiring similarity between data of adjacent frames is not limited in the present disclosure. Next, it is determined whether each similarity is less than a predetermined threshold value one by one. The predetermined threshold value may be set in advance or may be an empirical value. It could be understood that the predetermined threshold value may be any reasonable value, and the specific amount of the predetermined threshold value is not limited in the present disclosure. If the similarity between the data of adjacent frames is less than the predetermined threshold value, then the images corresponding to the data of the adjacent frames can be acquired as target images.

At step 303, the target terminal is controlled to display the target image at a visible position. Here, controlling the target terminal to display the target image at a visible position may be implemented as one of the following: controlling the target terminal to display each target image respectively at the visible position; controlling the target terminal to display some selected target images from the target images at the visible position; and controlling the target terminal to display a video or a dynamic image, which is generated based on the target images, at the visible position. It could be understood that the present disclosure is not limited in this regard.

Specifically, controlling the target terminal to display the target image at a visible position may include one or more of the following: controlling the target terminal to switch to displaying the target image; controlling the target terminal to display the target image in a desktop background; controlling the target terminal to display the target image in a lock screen background; and controlling the target terminal to display the target image in a floating window.

In one or more embodiments, controlling the target terminal to switch to displaying the target image may be implemented as controlling the target terminal to display target images in turn at the visible position. For example, supposing there are five target images, then the five target images may be displayed one by one at a visible position. Each target image may be displayed for a predetermined period (e.g., 5 seconds or 10 seconds etc.)

Controlling the target terminal to display the target image in a desktop background may be implemented as changing the desktop background of the target terminal to the target image. For example, after acquiring the target image, when the target terminal is displaying the desktop, then it may change the desktop background to the target image directly. In this way, a user can view the target image more quickly and conveniently, without opening a monitoring image display interface.

Controlling the target terminal to display the target image in a lock screen background may be implemented as changing the lock screen background of the target terminal to the target image. For example, after acquiring the target image, when the present target terminal is in a screen-sleep status, then it may directly light up the screen and change the screen lock background to the target image. In this way, a user can view the target image more quickly and conveniently, without opening a monitoring image display interface.

Controlling the target terminal to display the target image in a floating window may be implemented as displaying the target image in the floating window of the target terminal screen. For example, after acquiring the target image, when the present target terminal is being used by the user, then the present target terminal may generate a small floating window on the currently displayed interface and display the target image in this floating window. In this way, the user can view the target image more quickly and conveniently, without opening the monitoring image display interface.

It could be understood that there can be other ways to display the target image. Specific ways of displaying the target image are not limited in the present disclosure.

It should be noted that the same steps as those in the embodiment of FIG. 2 will not be described redundantly in the embodiment of FIG. 3 any longer. Reference can be made to the embodiment of FIG. 2 for the same contents.

According to the image outputting method provided by the foregoing embodiment of the present disclosure, data frames collected by a target camera is acquired, a target image indicating an abnormal event based on the data frames is acquired, and the target terminal is controlled to display the target image at a visible position. Thus, without opening a monitoring image display interface, a user can view the target image more quickly (upon occurrence of an abnormal event in a monitored target area) to get knowledge of the abnormal event, thereby increasing the effective utilization of the smart camera device.

It should be noted that, although operations of the method of the present disclosure have been described in a specific order in the attached drawings, this does not require or imply that these operations must be performed in accordance with the specific order or that all operations must be performed in order to achieve desired results. On the contrary, the order for executing steps illustrated in the flowchart can change. Additionally or alternatively, it is possible to omit some steps, combine multiple steps into one step for implementation, and/or divide one step into multiple steps for implementation.

Correspondingly to the foregoing embodiments of image outputting methods, the present disclosure further provides embodiments of image outputting apparatuses.

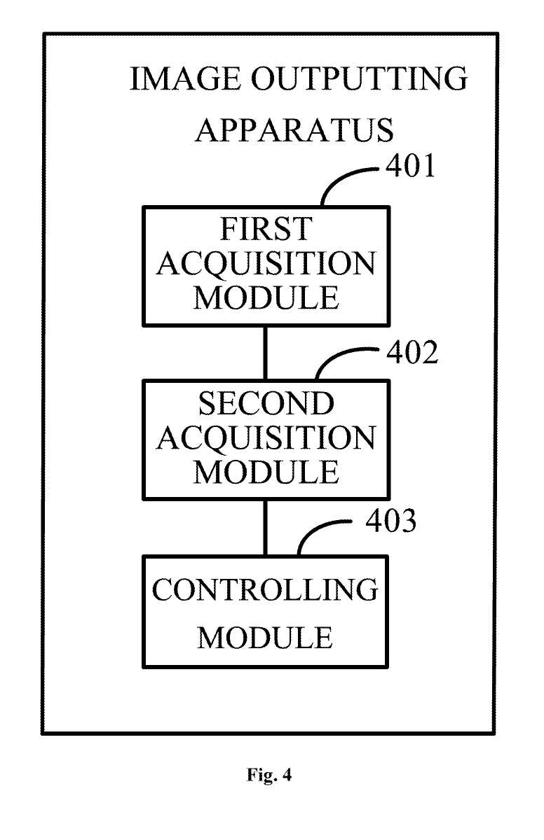

FIG. 4 is a block diagram illustrating an image outputting apparatus according to an exemplary embodiment of the present disclosure. As shown, the apparatus comprises: a first acquisition module 401, a second acquisition module 402, and a controlling module 403.

The first acquisition module 401 is configured to acquire data frames collected by a target camera.

The second acquisition module 402 is configured to acquire a target image based on data frames acquired by the first acquisition module 401.

The controlling module 403 is configured to control a target terminal to output an alert message which at least includes the target image acquired by the second acquisition module 402.

According to the image outputting apparatus provided by the foregoing embodiment of the present disclosure, data frames collected by a target camera is acquired, a target image is acquired based on the data frames, and the target terminal is controlled to output an alert message which at least includes the target image. Thus, when an emergency situation occurs in a user's home, the user can be notified of the emergency situation at once, thereby increasing the effective utilization of the smart camera device.

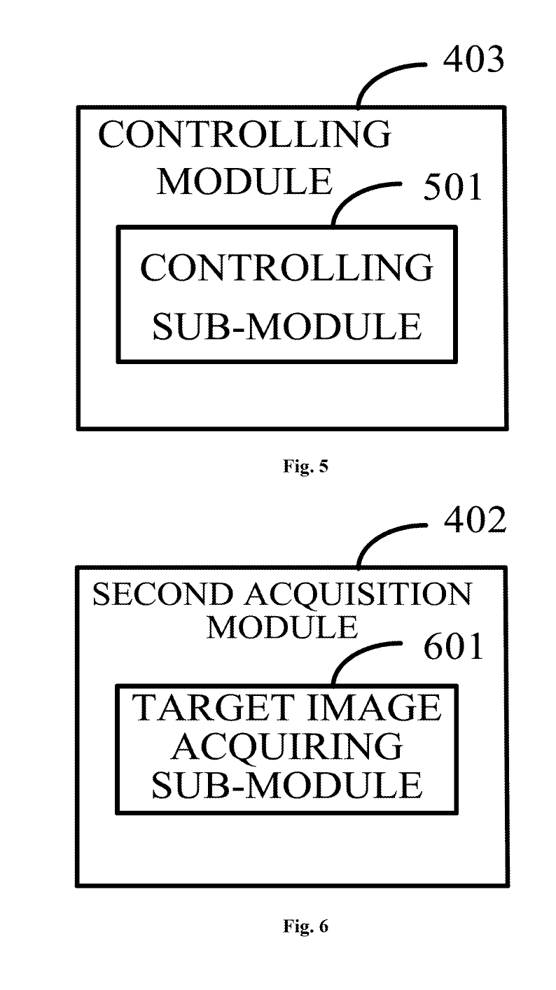

FIG. 5 is a block diagram illustrating another image outputting apparatus according to an exemplary embodiment of the present disclosure, which is on the basis of the above embodiment shown in FIG. 4. As shown, the controlling module 403 may comprise a controlling sub-module 501.

The controlling sub-module 501 is configured to control the target terminal to display the target image at a visible position.

In some optional embodiments, the controlling sub-module 501 may include one or more of a first display controlling sub-module, a second display controlling sub-module, a third display controlling sub-module and a fourth display controlling sub-module.

The first display controlling sub-module is configured to control the target terminal to switch to displaying the target image.

The second display controlling sub-module is configured to control the target terminal to display the target image in a desktop background.

The third display controlling sub-module is configured to control the target terminal to display the target image in a screen lock background.

The fourth display controlling sub-module is configured to control the target terminal to display the target image in the floating window.

FIG. 6 is a block diagram illustrating another image outputting apparatus according to an exemplary embodiment of the present disclosure, which is on the basis of the foregoing embodiment shown in FIG. 4. As shown, the second acquisition module 402 may comprise a target image acquiring sub-module 601.

The target image acquiring sub-module 601 is configured to acquire a target image indicating an abnormal event based on the foregoing data frames.

According to the image outputting apparatus provided by the foregoing embodiment of the present disclosure, a target image indicating an abnormal event is acquired based on the data frames, and the target terminal is controlled to output an alert message which at least includes the target image. Thus, when an emergency situation occurs in a user's home, the user can be notified of the emergency situation at once, thereby increasing the effective utilization of the smart camera device.

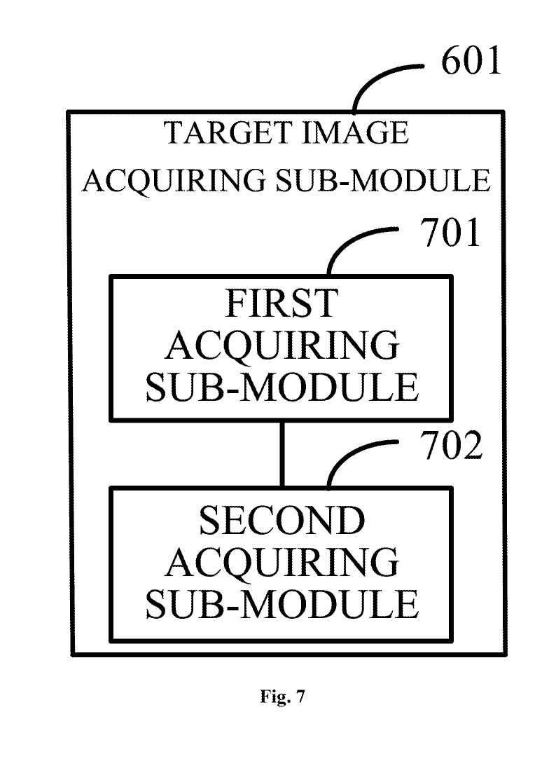

FIG. 7 is a block diagram illustrating another image outputting apparatus according to an exemplary embodiment of the present disclosure, which is on the basis of the foregoing embodiment shown in FIG. 6. As shown, the target image acquiring sub-module 601 may comprise a first acquiring sub-module 701 and a second acquiring sub-module 702.

The first acquiring sub-module 701 is configured to acquire similarity between data of adjacent frames among the data frames.

The second acquiring sub-module 702 is configured to acquire target images corresponding to the data of adjacent frames, when the similarity acquired by the first acquiring sub-module 701 is less than a predetermined threshold value.

According to the image outputting apparatus provided by the foregoing embodiment of the present disclosure, similarity between data of adjacent frames among the data frames is acquired; images corresponding to the data of adjacent frames are acquired as target images, when the similarity is less than a predetermined threshold value; and the target terminal is controlled to output an alert message which at least includes the target images. Thus, when an emergency situation occurs in a user's home, the user can be aware of it at once, thereby increasing the effective utilization of the smart camera device.

In some optional embodiments, the abnormal event may include one or more of the following events: a stranger has entered a target area; a location of an object in the target area has changed; and the target area has been on fire.

It should be understood that, the above apparatus may be set in advance in a smart camera device or in a server, and may also be loaded into the smart camera device or the server through downloading etc. Respective modules in the apparatus can cooperate with units in the smart camera device or the server to implement the image outputting solutions.

For the apparatus embodiment, reference can be made to the corresponding description of the method embodiment since it substantially corresponds to the method embodiment. The apparatus embodiment as described above is illustrative only. Those units described as discrete components may or may not be physically separated. Those components shown as units may or may not be physical units, i.e., they can either be co-located, or distributed over a number of network elements. Some or all of the modules can be selected as desired to achieve the object of the present disclosure, as can be understood and implemented by those skilled in the art without any inventive efforts.

Correspondingly, the present disclosure further provides an image outputting apparatus. The image outputting apparatus comprises a processor; and a memory storing instructions executable by the processor. The processor is configured to acquire data frames collected by a target camera, acquire a target image based on the data frames and control a target terminal to output an alert message which at least includes the target image.

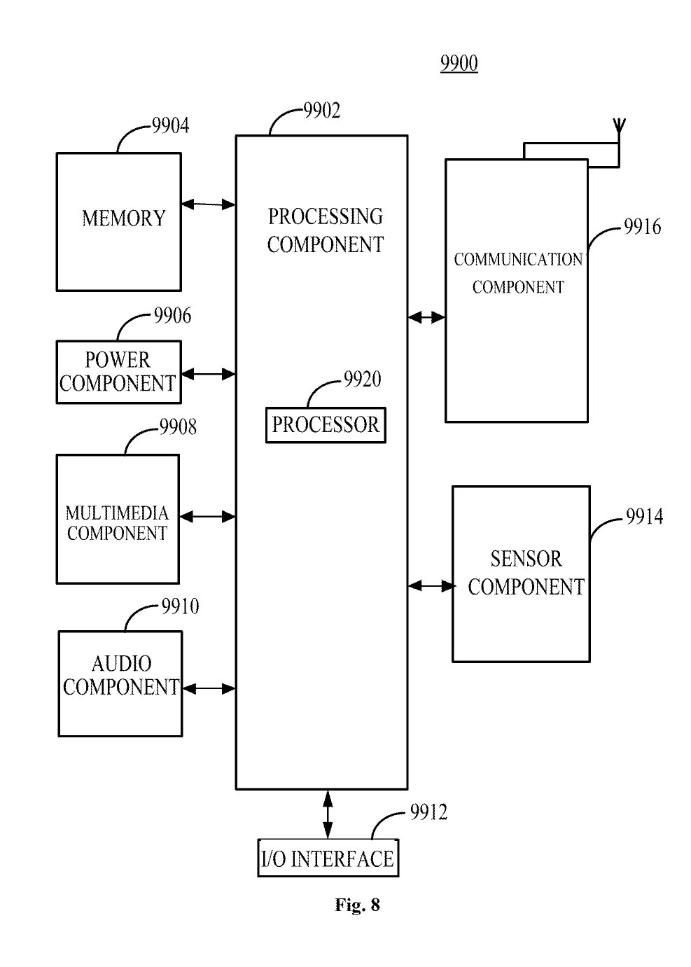

FIG. 8 is a structure schematic diagram illustrating an image outputting apparatus 9900 according to an exemplary embodiment. For example, the apparatus 9900 may be a mobile phone, a computer, a digital broadcast terminal, a messaging device, a gaming console, a tablet, a medical device, exercise equipment, a personal digital assistant or the like.

Referring to FIG. 8, the apparatus 9900 may include one or more of the following components: a processing component 9902, a memory 9904, a power component 9906, a multimedia component 9908, an audio component 9910, an input/output (I/O) interface 9912, a sensor component 9914 and a communication component 9916.

The processing component 9902 generally controls the overall operations of the apparatus 9900, for example, display, phone call, data communication, camera operation and recording operation. The processing component 9902 may include one or more processors 9920 to execute instructions to perform all or part of the steps in the above described methods. In addition, the processing component 9902 may include one or more modules to facilitate the interaction between the processing component 9902 and other components. For example, the processing component 9902 may include a multimedia module to facilitate the interaction between the processing component 9908 and the processing component 9902.

The memory 9904 is configured to store various types of data to support the operation performed on the apparatus 9900. Examples of such data include instructions for any applications or methods operated on the apparatus 9900, contact data, phonebook data, messages, pictures, video, etc. The memory 9904 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 9906 provides power to various components of the apparatus 9900. The power component 9906 may include a power supply management system, one or more power sources, and any other components associated with the generation, management, and distribution of power in the apparatus 9900.

The multimedia component 9908 includes a screen providing an output interface between the apparatus 9900 and the user. In some embodiments, the screen may include a Liquid Crystal Display (LCD) and a Touch Panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 9908 includes a front camera and/or a rear camera. The front camera and the rear camera may receive external multimedia data while the apparatus 9900 is in an operation mode, such as a photographing mode or a video mode. Each of the front camera and the rear camera may be a fixed optical lens system or have focus and optical zoom capability.

The audio component 9910 is configured to output and/or input audio signals. For example, the audio component 9910 includes a microphone (“MIC”) configured to receive an external audio signal when the apparatus 9900 is in an operation mode, such as a call mode, a recording mode, and a voice recognition mode. The received audio signal may be further stored in the memory 9904 or transmitted via the communication component 9916. In some embodiments, the audio component 9910 further includes a speaker to output audio signals.

The I/O interface 9912 provides an interface between the processing component 9902 and peripheral interface modules, such as a keyboard, a click wheel, buttons, and the like. The buttons may include, but are not limited to, a home button, a volume button, a starting button, and a locking button.

The sensor component 9914 includes one or more sensors to provide status assessments of various aspects of the apparatus 9900. For instance, the sensor component 9914 may detect an open/closed status of the apparatus 9900, relative positioning of components, e.g., the display and the keypad, of the apparatus 9900, a change in position of the apparatus 9900 or a component of the apparatus 9900, a presence or absence of user contact with the apparatus 9900, an orientation or an acceleration/deceleration of the apparatus 9900, and a change in temperature of the apparatus 9900. The sensor component 9914 may include a proximity sensor configured to detect the presence of nearby objects without any physical contact. The sensor component 9914 may also include a light sensor, such as a CMOS or CCD image sensor, for use in imaging applications. In some embodiments, the sensor component 9914 may also include an accelerometer sensor, a gyroscope sensor, a magnetic sensor, a pressure sensor, a microwave sensor or a temperature sensor.

The communication component 9916 is configured to facilitate wired or wireless communication between the apparatus 9900 and other devices. The apparatus 9900 can access a wireless network based on a communication standard, such as WiFi, 2G; or 3G; or a combination thereof. In one exemplary embodiment, the communication component 9916 receives a broadcast signal or broadcast related information from an external broadcast management system via a broadcast channel. In one exemplary embodiment, the communication component 9916 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 9900 may be implemented with one or more circuitries, which include application specific integrated circuits (ASIC), digital signal processors (DSP), digital signal processing devices (DSPD), programmable logic devices (PLD), field programmable gate arrays (FPGA), controllers, micro-controllers, microprocessors, or other electronic components. The apparatus 9900 may use the circuitries in combination with the other hardware or software components for performing the above described methods. Each module, sub-module, unit, or sub-unit in the disclosure may be implemented at least partially using the one or more circuitries.

In exemplary embodiments, there is also provided a non-transitory computer-readable storage medium including instructions, such as included in the memory 9904, executable by the processor 9920 of the apparatus 9900, for performing the above-described methods. For example, the non-transitory computer-readable storage medium may be a ROM, a RAM, a CD-ROM, a magnetic tape, a floppy disc, an optical data storage device, and the like.

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the appended claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. An image outputting method, comprising:
acquiring data frames collected by a target camera;
acquiring a target image based on the data frames; and
controlling a target terminal to output an alert message that at least includes the target image.

2. The method according to claim 1, wherein controlling the target terminal to output the alert message comprises:
controlling the target terminal to display the target image at a visible position.

3. The method according to claim 2, wherein controlling the target terminal to display the target image at the visible position includes one or more of the following:
controlling the target terminal to switch to displaying the target image;
controlling the target terminal to display the target image in a desktop background;
controlling the target terminal to display the target image in a lock screen background; and
controlling the target terminal to display the target image in a floating window.

4. The method according to claim 1, wherein acquiring the target image based on the data frames comprises:
acquiring a target image indicating an abnormal event based on the data frames.

5. The method according to claim 4, wherein acquiring the target image indicating an abnormal event based on the data frames comprises:
acquiring similarity between data of adjacent frames among the data frames; and
acquiring target images corresponding to the data of adjacent frames when the similarity is less than a predetermined threshold value.

6. The method according to any of claim 4, wherein the abnormal event includes one or more of the following :
a target area;
an object in the target area has changed; and
a time period to watch the target area.

7. The method according to any of claim 4, wherein the abnormal event is defined by one or more of the following: an application scenario, an object image in the application scenario, and an acceptable identity photo.

8. The method according to any of claim 4, wherein the abnormal event is defined by one or more of the following:
a stranger photo;
a target area; and
an object in the target area.

9. The method according to any of claim 4, wherein the abnormal event is defined by one or more of the following:
a target area; and
a type of hazard in the target area.

10. The method according to any of claim 4, wherein the abnormal event includes one or more of the following events:
a stranger has entered a target area;
a location of an object in the target area has changed; and
the target area has been on fire.

11. An image outputting apparatus, comprising:
a processor; and
a memory storing instructions executable by the processor,
wherein the processor is configured to:
acquire data frames collected by a target camera;
acquire a target image based on the data frames; and
control a target terminal to output an alert message that at least includes the target image.

12. The image outputting apparatus according to claim 11, wherein controlling the target terminal to output the alert message comprises: controlling the target terminal to display the target image at a visible position.

13. The image outputting apparatus according to claim 12, wherein controlling the target terminal to display the target image at the visible position includes one or more of the following:
controlling the target terminal to switch to displaying the target image;
controlling the target terminal to display the target image in a desktop background;
controlling the target terminal to display the target image in a lock screen background; and
controlling the target terminal to display the target image in a floating window.

14. The image outputting apparatus according to claim 11, wherein acquiring the target image based on the data frames comprises:
acquiring a target image indicating an abnormal event based on the data frames.

15. The image outputting apparatus according to claim 14, wherein acquiring the target image indicating an abnormal event based on the data frames comprises:
acquiring similarity between data of adjacent frames among the data frames; and
acquiring target images corresponding to the data of adjacent frames when the similarity is less than a predetermined threshold value.

16. The image outputting apparatus according to claim 14, wherein the abnormal event is defined by one or more of the following:
a target area;
an object in the target area; and
a time period to watch the target area.

17. A non-transitory computer-readable storage medium having stored therein instructions that, when executed by a processor of a mobile terminal, cause the mobile terminal to perform acts comprising:
acquiring data frames collected by a target camera;
acquiring a target image based on the data frames; and
controlling a target terminal to output an alert message that at least includes the target image.

18. The non-transitory computer-readable storage medium according to claim 17, wherein controlling the target terminal to output the alert message comprises: controlling the target terminal to display the target image at a visible position.

19. The non-transitory computer-readable storage medium according to claim 18, wherein controlling the target terminal to display the target image at the visible position includes one or more of the following:
controlling the target terminal to switch to displaying the target image;
controlling the target terminal to display the target image in a desktop background;
controlling the target terminal to display the target image in a lock screen background; and
controlling the target terminal to display the target image in a floating window.

20. The non-transitory computer-readable storage medium according to claim 17, wherein acquiring the target image based on the data frames comprises:
acquiring a target image indicating an abnormal event based on the data frames;
acquiring similarity between data of adjacent frames among the data frames; and
acquiring target images corresponding to the data of adjacent frames when the similarity is less than a predetermined threshold value.
